(19) United States
(12) Patent Application Publication
(10) Pub. No.: US 2008/0290583 A1
(43) Pub. Date: Nov. 27, 2008

(54) IMAGE FORMING APPARATUS AND METHOD, AND STORAGE MEDIUM STORING PROGRAM SEGMENT FOR EXECUTING THE METHOD

(76) Inventors: Naohiko KUBO, Yokohama-shi (JP); Yutaka Matsumoto, Saitama-shi (JP); Satoshi Miyazaki, Kawasaki-shi (JP); Hiroshi Gotoh, Tokyo (JP); Takeshi Yoshizumi, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/125,390

(22) Filed: May 22, 2008

(30) Foreign Application Priority Data
May 22, 2007 (JP) 2007-135960

(51) Int. Cl. B65H 3/00; B41F 13/00; G06F 7/06

(52) U.S. Cl. 271/9.01; 270/1.01; 700/225

(57) ABSTRACT

An image forming apparatus includes a plurality of sheet feed trays, a tray information management unit, a sheet feed control unit, and an image forming unit. The sheet feed trays contain recording sheets. The tray information management unit manages tray information in which tray identification information on the sheet feed trays is associated with sheet type information on sheet types of recording sheets contained in the sheet feed trays. The sheet feed control unit selects, from among the sheet feed trays, one sheet feed tray containing a recording sheet of one sheet type designated in an image forming request by referring to the tray information, and controls a sheet feeding operation for feeding the recording sheet from the selected tray. The image forming unit forms an image on the recording sheet fed from the selected tray according to image forming data input with the image forming request.

### CROSS-REFERENCE TO RELATED APPLICATIONS

The present patent application claims priority under 35 U.S.C. §119 from Japanese Patent Application No. 2007-135960, filed on May 22, 2007 in the Japan Patent Office, the entire contents of which are hereby incorporated herein by reference.

### BACKGROUND OF THE INVENTION

1. Field of the Invention

The present invention relates generally to an image forming apparatus capable of controlling a sheet feeding operation to feed a recording medium to an image forming unit in response to a print request.

2. Description of the Background

Image forming apparatuses are used as copiers, facsimile machines, printers, and multi-functional devices combining several of the foregoing capabilities.

Conventionally, certain types of image forming apparatuses have a plurality of sheet feed trays containing a plurality of types of recording media (hereinafter “sheet” or “sheets”) different in size and material. In a sheet feeding operation, such image forming apparatus selects one sheet feed tray from among the plurality of sheet feed trays and feeds a sheet from the selected tray.

In one method, sheets of a frequently-used type are stored in two or more sheet feed trays of a plurality of sheet feed trays. Such method is implemented in a certain type of image forming apparatus as a limitless feeding function. In such limitless feeding function, when a first sheet feed tray runs out of sheets, the active tray is automatically switched to a second sheet feed tray containing sheets of a type identical to the first-selected sheet.

For example, one conventional type of printer having such limitless feeding function searches a plurality of sheet feed trays for conditions such as identical sheet type and size or no tray lock. When a sheet feed tray meeting such conditions is found, the conventional printer switches the active tray from the first-selected tray to the newly-found tray to perform a limitless sheet feed operation.

For example, in one limitless feeding method, a priority order is assigned to a plurality of sheet feed trays capable of performing such limitless feed operation. When a sheet feed tray having a highest priority runs out of sheets, a sheet is fed from a sheet feed tray having a second highest priority.

However, regarding the conventional type of printer, although the method of searching the plurality of sheet feed trays is defined, sufficient consideration is not given to a timing of executing the search or a transfer of active tray information between successive print jobs. Consequently, when print operations are repeated, only a particular sheet feed tray runs out of sheets while sheets of identical size remain in other sheet feed trays capable of performing the limitless sheet feed operation.

Further, as described above, in the above-described conventional printer in which a priority order is assigned to the plurality of sheet feed trays, for example, when the sheet feed tray having the highest priority runs out of sheets, the active tray is switched from the highest-prioritized tray to the second-highest priority tray. However, if sheets are supplied or reloaded to the highest prioritized tray between pages or print jobs, the sheets are fed from the highest prioritized tray again rather than the second-highest priority tray. Consequently, sheets may remain unused in other lower-priority trays capable of performing such limitless feed operation.

Further, when supplying a stack of sheets to a sheet feed tray in which some sheets remain unused, it may take a user the following extra time and effort.

For example, the capacity of such sheet feed trays is typically designed in units of 500 sheets. Therefore, when some sheets remain in a sheet feed tray, it may take a user extra time and effort to separate an appropriate number of sheets from a packaged stack of 500 sheets in order to supply the appropriate number of sheets into the sheet feed tray, compared to when no sheets remain in the sheet feed tray.

Consequently, there is still a need for an image forming apparatus capable of controlling a sheet feed operation to select one sheet feed tray from a plurality of sheet feed trays and to continuously feed sheets from the selected tray until the selected tray runs out of sheets, thereby reducing time and effort for a user to reload a sheet stack into the tray.

### SUMMARY OF THE INVENTION

Exemplary embodiments of the present invention provide an image forming apparatus capable of controlling a sheet feed operation to select one sheet feed tray from a plurality of sheet feed trays and to continuously feed sheets from the selected tray until the selected tray runs out of sheets, thereby reducing time and effort for a user to reload a sheet stack into the tray.

In one exemplary embodiment of the present invention, an image forming apparatus includes a plurality of sheet feed trays, a tray information management unit, a sheet feed control unit, and an image forming unit. The plurality of sheet feed trays contain recording sheets. The tray information management unit associates tray identification information on the plurality of sheet feed trays with sheet type information on sheet types of recording sheets contained in each sheet feed tray of the plurality of sheet feed trays as tray information. The sheet feed control unit selects, from among the plurality of sheet feed trays, one sheet feed tray containing a recording sheet of one sheet type designated in an image forming request by referring to the tray information managed by the tray information management unit, and controls a sheet feeding operation for feeding the recording sheet from the selected sheet feed tray. The image forming unit forms an image on the recording sheet fed from the selected sheet feed tray according to image forming data input with the image forming request.

### BRIEF DESCRIPTION OF THE DRAWINGS

A more complete appreciation of the disclosure and many of the attendant advantages thereof will be readily acquired as the same becomes better understood by reference to the following detailed description when considered in connection with the accompanying drawings, wherein:

FIG. 1 is a block diagram illustrating a hardware configuration of an image forming apparatus according to an exemplary embodiment of the present invention;

FIG. 2 illustrates an example of a sheet-tray table in which each sheet size is associated with one sheet feed tray;

FIG. 3 is a flow chart illustrating a sheet feed control process executed for print output using a sheet-tray table;

FIG. 4 illustrates an example of a sheet-tray table in which sheet sizes are associated with prioritized tray numbers indicating sheet feed trays; and

FIG. 5 is a setting screen of an operation panel for selecting a tray usage order.

The accompanying drawings are intended to depict exemplary embodiments of the present disclosure and should not be interpreted to limit the scope thereof. The accompanying drawings are not to be considered as drawn to scale unless explicitly noted.

### DETAILED DESCRIPTION OF EXEMPLARY EMBODIMENTS

In describing exemplary embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve the same results. For the sake of simplicity, the same reference numerals are used in the drawings and the descriptions for the same materials and constituent parts having the same functions, and redundant descriptions thereof are omitted.

Exemplary embodiments of the present disclosure are now described below with reference to the accompanying drawings. It should be noted that, in a later-described comparative example, exemplary embodiment, and alternative example, the same reference numerals are used for the same constituent elements such as parts and materials having the same functions and achieving the same effects, and redundant descriptions thereof are omitted.

Hereinafter, a description is given of an exemplary embodiment of an image forming apparatus capable of managing tray information used to control a sheet feeding operation so as to continuously feed sheets from one sheet feed tray until the sheet feed tray runs out of the sheets.

Incidentally, in the present exemplary embodiment, a description is mainly given of a printing operation that an image forming apparatus performs in response to a processing request sent from an external host machine, such as a host computer, connected via a communication interface (I/F) through a network or directly connected to the image forming apparatus. It should be noted that, when the image forming apparatus itself stores data, the image forming apparatus may perform a printing operation according to a processing request sent via an operation panel provided to the image forming apparatus.

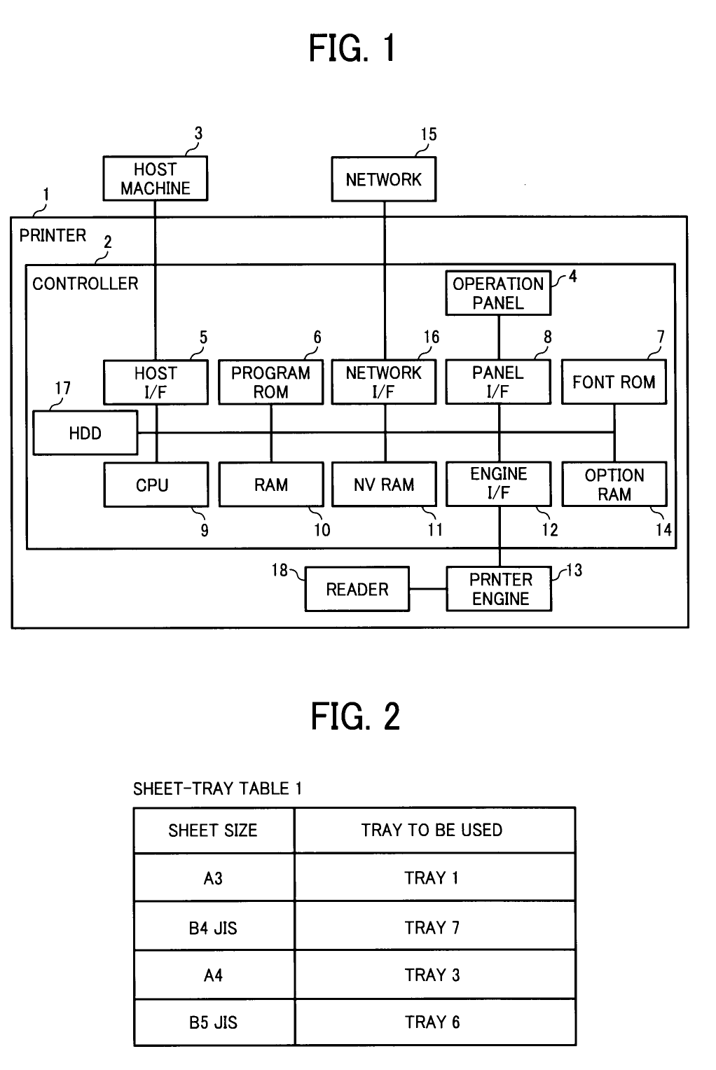

FIG. 1 is a block diagram illustrating a hardware configuration of an image forming apparatus according to the present exemplary embodiment.

As illustrated in FIG. 1, the image forming apparatus 1 has a controller 2. The controller 2 is a general control system that converts print data designated by a print request into video data according to a control mode determined when receiving the print request and to a control code sent directly from a host machine 3 or via a network 15, and outputs the video data to a printer engine 13. The controller 2 includes modules as follows.

A host interface (I/F) 5 is an interface for control signals and data sent from the host machine 3 to the image forming apparatus 1 and for status signals sent from the image forming apparatus 1 to the host machine 3.

A CPU 9 processes the data, such as print data or control data, sent from the host machine 3 according to a program ROM (read-only memory) 6. Control data is data that specifies a control condition for each processing unit to perform print output. The control data may be designated through the print request or a default setting of an operational panel, later described, of the image forming apparatus 1. The controller 2 sets processing or operating conditions of the CPU 9 through the control data.

A RAM (random access memory) 10 is a working memory that the CPU 9 uses to execute processing. For example, the RAM 10 is used as a buffer memory for temporarily storing the data sent from the host machine 3 in units of pages and a bit-map memory for storing the video data obtained by converting the data stored in the buffer memory into a print pattern to be actually printed.

The program ROM 6 stores programs for processing and managing data in the controller 2 and for controlling peripheral modules. For example, the program ROM 6 stores a program for executing processing for managing tray information, later described.

A HDD (hard disk drive) 17 is a storage device capable of storing a large amount of data and retaining such data while power is turned off. Accordingly, the HDD 17 stores data according to such characteristic.

A NV-RAM 11 is a non-volatile random access memory capable of retaining data even when the power is turned off and is accessible at a speed higher than the HDD 17. Accordingly, the NV-RAM 11 stores data according to such characteristic.

The font ROM 7 stores various types of font data used for printing.

An engine I/F (interface) 12 is an interface for transmitting and receiving the control signals and video signals sent from the controller 2 to the printer engine 13 and the status signals sent from the printer engine 13 to the controller 2.

The printer engine 13 is an engine unit that forms an image by an electrophotographic process. Specifically, the printer engine 13 forms an electrostatic latent image on a photoconductor according to the video signals and control signals sent from the controller 2, and transfers and fixes a toner image on a transfer sheet or recording medium, which is fed from a sheet feed unit. Thus, the printer engine 13 performs a series of image forming processes to form a desired image on the transfer sheet.

In the present exemplary embodiment, a sheet feed section has a plurality of sheet feed trays. The controller 2 designates one sheet feed tray from among the plurality of sheet feed trays to feed a sheet in a printing operation.

A reader 18 is a device that reads information on various replaceable components in the printer engine 13. For example, the reader 18 reads a bar code or other data inscribed on a label attached to such replaceable component to obtain information on such component. The read data is then transmitted to the controller 2 through the engine I/F 12. For example, the reader 18 is used to read information on sheets stored in each sheet feed tray from a label attached to a housing of each sheet feed tray.

An operation panel 4 serving as an operation unit includes a display section that displays a status of the image forming apparatus 1 and a switching section that switches modes, fonts, and the like. The display and switching sections may be LCD (liquid crystal display) touch panels to provide users with a GUI (graphical user interface) function.

A panel I/F (interface) 8 is an interface between the controller 2 and the operation panel 4.

Next, a description is given of data processing executed in the image forming apparatus 1 having the above-described configuration.

The controller 2 receives a job such as a print request sent from the host machine 3. Such job is created by a printer driver of the host machine 3. In such job created by the printer driver, a processing condition set through a user interface is attached as control data to the print data designated in the print request.

In the controller 2 receives the job sent from the host machine 3 through the host I/F 5, the CPU 9 uses a data analysis program stored in the program ROM 6 to analyze the received job and separate the print data and the print control data from other data. Such print control data may include SP (space), CR (carriage return), LF (line feed), HT (horizontal tabulation), VT (vertical tabulation), or other code.

The print data and the print control data are temporarily stored in a receiving buffer of the RAM 10. A control program in the program ROM 6 retrieves such data one by one from the RAM 10 and executes particular types of processing thereon, depending on the type of data retrieved. For example, when such retrieved data is a character code, an intermediate code including print position, print size, character code, font information, and other information is created and stored in an intermediate buffer provided in the RAM 10.

Alternatively, when such retrieved data is a control code or a command such as an escape sequence, certain processing corresponding to its data type is executed thereon. For example, when a print position is designated in such retrieved data, a subsequent character code is set to the designated print position. Alternatively, when font change is designated, the font information of a subsequent character code is changed into a designated font.

When the processing based on the print instruction from the host machine 3 is finished or when the amount of processed data exceeds the amount of data for one page, the intermediate code stored in the intermediate buffer is converted into video data according to a control program. When the conversion is finished, the controller 2 issues an instruction for starting printing to the printer engine 13 via the engine I/F 12 and transmits the video data at a timing synchronized with the start of printing.

Thus, in the above-described procedure, the controller 2 instructs the printer engine 13 to print the print data according to the print request sent from the host machine 3 to produce print output.

Next, a detailed description is given of an example of management of tray information or control information used to control sheet feeding operation in the image forming apparatus 1.

In the above-described data processing procedure, when printing, the controller 2 controls the print data to be printed on a sheet of a type designated in a print request. As described above, the plurality of sheet feed trays contains various types of sheets. The controller 2 selects one sheet feed tray matching a user's request from among the plurality of sheet feed trays and feeds a sheet from the selected tray.

When a user requests printing through the user I/F of the printer driver, typically the user designates a desired sheet size and type. The controller 2 selects one sheet feed tray containing a requested sheet based on the sheet size and type designated in the print request, sets the selected tray as a tray to be used for sheet feeding, and causes the selected tray to feed the requested sheet.

In this regard, such user's request may be performed by directly designating one sheet feed tray from among a plurality of sheet feeding trays. Typically, such method is used to feed a specialized sheet from a predefined sheet feed tray, and therefore is not described in the present exemplary embodiment.

In the present exemplary embodiment, “tray information” is used to select one sheet feed tray containing sheets of a type designated in a print request from among the plurality of sheet feed trays. In the tray information, sheet-type information on the type of sheets stored in each sheet feed tray is associated with tray identification (ID) information on each sheet feed tray.

Such tray information may be managed in the form of, for example, a table in which the sheet-type information is associated with the tray ID information. Incidentally, in the following description, for simplicity only sheet size is described as such sheet type, and such association table is referred to as “sheet-tray table”.

FIG. 2 illustrates an example of a sheet-tray table 1 in which each sheet size is associated with one sheet feed tray.

In the sheet-tray table 1 of FIG. 2, four different size sheets (A3, B4 JIS, A4, and B5 JIS) are associated with four different sheet feed trays of different tray numbers.

For example, the image forming apparatus 100 may have seven sheet feed trays as the plurality of sheet feed trays. In such case, as illustrated in FIG. 2, A3-, B4-JIS-, A4-, and B5-JIS-size sheets are stored in four sheet feed trays having tray numbers described in the sheet-tray table 1.

Alternatively, when sheets are stored in all the seven sheet feed trays, sheets of a frequently used size may be stored in the remaining sheet feed trays not described in the sheet-tray table 1 of FIG. 2. In such case where sheets of an identical size are stored in two or more sheet feed trays, the image forming apparatus 1 is capable of performing “limitless” sheet feeding. Here, “limitless” sheet feeding refers to an sheet feeding operation in which, when a first sheet feed tray runs out of sheets of one sheet size, the image forming apparatus 1 switches the active tray from the first sheet feed tray to a second sheet feed tray storing sheets of the identical sheet size and continuously feeds the sheets of the identical size.

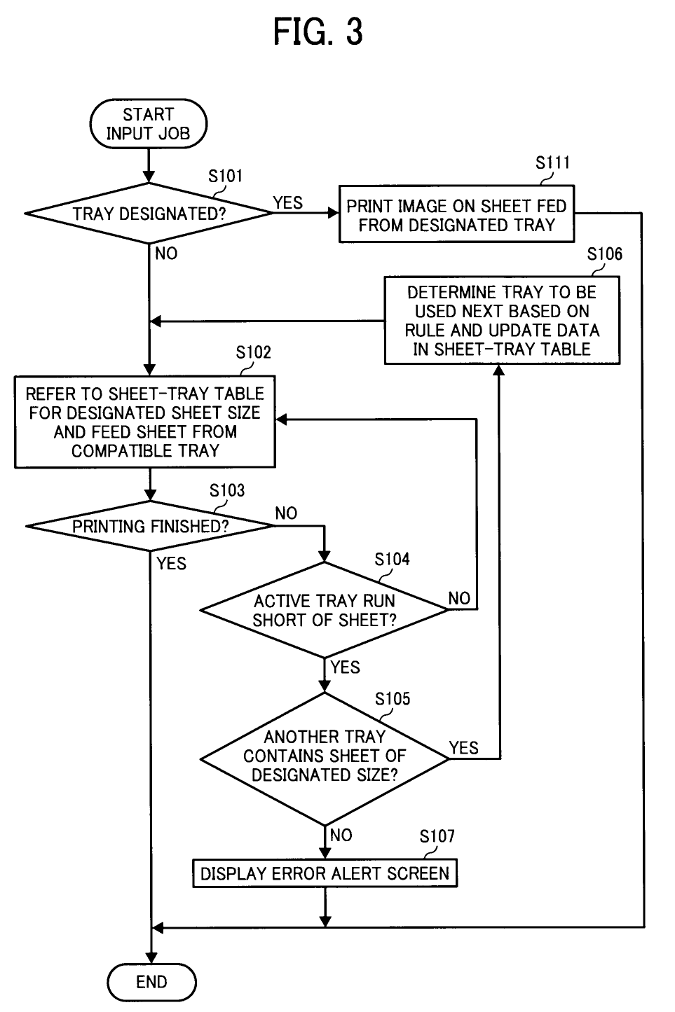

Next, a description is given of an example of sheet feed control conducted using the above-described sheet-tray table 1, with reference to a control process illustrated in FIG. 3.

In the control process of FIG. 3, the controller 2 functions as a portion of a control program activated to process a print operation for a current job and controls operation of the printer engine 13. Incidentally, the control process shown in FIG. 3 focuses on the sheet feeding control, with other control processes omitted for simplicity.

When the control process is started, at step S101 it is determined whether or not a sheet feed tray to be used is designated in a print job for requesting print.

In the case where the sheet feed tray to be used is designated (“YES” at step S101, typically such designation is executed with a setting in which, for example, a specialized sheet is stored in a certain sheet feed tray. Then, according to such designation, sheets in the designated sheet feed tray are used for printing at step S111, and the control process ends.

Alternatively, if a sheet feed tray to be used is not designated (“NO” at step S101), typically a sheet size to be used is designated in a print job. Accordingly, at step S102, one sheet feed tray is selected based on the sheet size designated by a user, and a sheet is fed from the selected sheet feed tray. In the present exemplary embodiment, the sheet feed tray to be used is selected by referring to the sheet-tray table 1 of FIG. 2 managed by the controller 2.

The sheet feeding operation from the sheet feed tray selected at step S102 may inadvertently stop before the active print job is finished. Accordingly, when the sheet feeding stops, at step S103 it is checked whether or not the active print job has been finished.

For example, when the sheet feed tray in use runs out of sheets or when the sheet feed tray in use is opened during execution of the print job, the sheet feeding operation may inadvertently stop before the active print job is finished. Further, for example, when all sheets in the tray selected for printing are used or when sheets in the selected tray are replaced with sheets of a size different from the designated size, the sheet feed tray in use runs out of sheets.

In either of the above-described cases where the sheet feeding operation inadvertently stops, it is necessary to continue the sheet feeding operation normally. Accordingly, in this control process, when the active print job is not finished (“NO” at step S103), at step S104 it is determined whether or not the selected sheet feed tray is out of sheets.

If the selected sheet feed tray contains sheets of the designated size (“NO” at step S104), the operation at step S102 is directly continued. That is, the sheets of the designated size are continuously fed from the selected sheet feed tray.

Alternatively, if the selected sheet feed tray is actually out of sheets of the designated size (“YES” at step S104), at step S105 it is checked whether or not another sheet feed tray contains sheets of the designated size.

If no other sheet feed tray contains the sheets of the designated size (“NO” at step S105), the print job is not completed, and at step S107 an alert indicating that the requested printing is not completed due to lack of sheets is displayed on the screen of the operation panel 4 and this control process ends.

Alternatively, if one or more other sheet feed trays contain sheets of the designated size (“YES” at step S105), one sheet feed tray to be used next is selected from among the sheet feed tray(s). To change the active tray from the first-selected tray to the newly selected tray, the data in the sheet-tray table 1 of FIG. 2 is updated at step S106.

When selecting the tray to be used next, one sheet feed tray is selected according to a certain rule based on an assumption that a plurality of other sheet feed trays contains sheets of the designated size.

An example of the rule is a predetermined order in which the sheet feed trays are to be used. Such predetermined order may be used as follows. For example, in the present exemplary embodiment, sheet information such as the size of sheets stored in each sheet feed tray may be represented as a bar code on a label attached to the housing of each sheet feed tray to be read by the reader 18. Such reading operation is performed in a manner that the reader 18 scans the sheet feed trays in a predetermined order of, for example, tray 1, tray 2, tray 3, . . . tray N, tray 1, . . . .

Such tray scanning order may be also used as the predetermined order in which the sheet feed trays are used. According to the predetermined order, it is checked whether or not each sheet feed tray contains sheets of the designated size. If another sheet feed tray containing sheets of the designated size is found, the sheet feed tray is selected to feed the sheets. Thus, the acquisition of information on sheet size can be performed in parallel with the determination of sheet feed tray to be used, thereby simplifying the sheet feed operation.

At step S106, the tray to be used next is determined according to the above-described manner and the data of the sheet-tray table 1 is updated. Then, the process returns to step S102.

At step S102, the sheet feed tray to be used next is determined by referring to the updated sheet-tray table 1. Then, the active tray is changed to the tray newly selected at step S106, and sheet feeding is started from the newly selected tray. As a result, the print job held in a state in which sheet feeding is stopped is continuously executed.

In the case where one or more sheet feed trays contains sheets of the designated size, when all the sheets are used in one sheet feed tray, the above-described process from step S102 to S106 is repeated for other sheet feed trays according to the predetermined order.

If the printing is finished (“YES” at step S103), the control process ends.

As described in the control process, the image forming apparatus 1 manages a sheet-tray table in which sheet sizes ready to be fed are associated with tray numbers of the respective sheet feed trays. Through the management of such sheet-tray table, the image forming apparatus 1 is capable of feeding sheets continuously from the active tray until the active tray runs out of sheets without switching the active tray to another tray between pages or between jobs, which may be performed in a conventional sheet feeding operation. As a result, a user can directly supply a sheet stack to the sheet feed tray having run out of sheets, thereby reducing the work of the user.

In the above-described exemplary embodiment, a basic configuration of sheet feeding control and management of control information used for the sheet feeding control is described.

Below, other exemplary embodiments based on the basic configuration and capable of further enhancing the above-described sheet feed operation using all sheets in an active sheet feed tray are described.

[Variable Tray-Usage Order]

First, an exemplary embodiment capable of changing an order in which the sheet feed trays are used is described.

In the above-described exemplary embodiment, a predetermined order is used as the rule for determining a tray to be used next. By contrast, in the exemplary embodiment described below, such order in which the sheet feed trays are used is variable according to a certain rule, described later.

As described in the above-described exemplary embodiment, sheets are continuously fed from an active sheet feed tray until the active tray runs out of the sheets. When all the sheets in the active tray are used, a sheet feed tray to be used next is selected according to the rule.

However, a variation may be generated, for example, when sheets are supplied to another sheet feed tray containing sheets of the designated size between sheet feed operations from the active sheet feed tray. Consequently, when the sheet feed trays are used according to a predetermined priority order, such variation may result in a deviation from a preferable usage state.

Hence, according to the present exemplary embodiment, the usage order of the sheet feeding trays is changeable to maintain a preferable usage state.

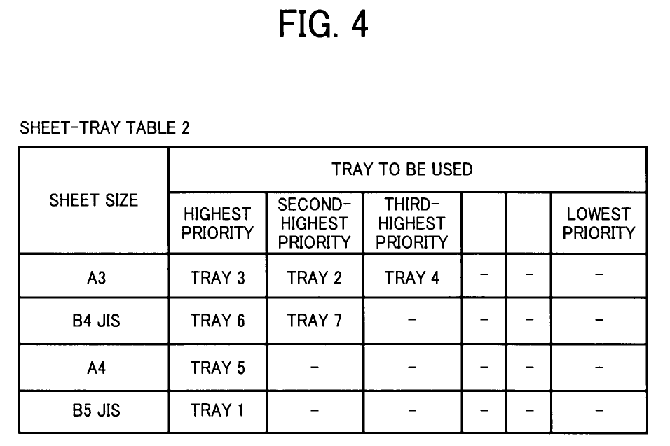

FIG. 4 illustrates an example of a sheet-tray table 2 in which sheet feed trays are associated with prioritized tray numbers indicating sheet feed trays.

The sheet-tray table 2 of FIG. 4 includes the tray numbers indicating the sheet feed trays to be selected corresponding to four different sheet sizes of A3, B4 JIS, A4, and B5 JIS. In this example, seven sheet feed trays having respective tray numbers with priorities are associated with A3-, B4-JIS-, A4-, and B5-JIS-size sheets. For example, A3-size sheet is associated with tray 3, tray 2, and tray 4, to which priority of usage is assigned in that order.

Thus, when sheets of identical size are stored in a plurality of sheet feed trays, the order in which the sheet feed trays are used in a limitless sheet feed operation is determined according to the tray usage priority stored in the table.

Such tray usage order is determined according to a certain rule described later, is managed as usage-order setting information, and is reflected in the sheet-tray table 2 of FIG. 4.

When a variation in the number of remaining sheets in each sheet feed tray is expected to be generated by a sheet supply operation and so on, such usage-order setting information is obtained. By contrast, when no variation is expected, the previously obtained information may continue to be used, and accordingly the sheet-tray table 2 does not need to be updated.

In this regard, such variation in the number of remaining sheets due to sheet supply may be predicted by detecting the opening and closing of the sheet feed trays. Alternatively, such variation may be detected at a certain time interval in another suitable manner.

Accordingly, in this exemplary embodiment in which the tray usage order is variably set, the update of table data, which is executed at step S106 in the case of the control process of FIG. 3, is executed separately from the control process of FIG. 3. Except the update of table data, the sheet feed control using the sheet-tray table 2 is performed based on the control process of FIG. 3.

Incidentally, the management of the sheet-tray table 2 when turning the power on and off or when switching print jobs is described later.

[Usage-Order Determination Rule 1]

Next, a description is given of a rule for determining such variable tray-usage order.

One example of the rule is a rule that the tray usage order is determined according to the chronologically ascending order of sheet supply to the respective sheet feed trays, that is, the order of earlier sheet supply (hereinafter “usage-order determination rule 1”).

To manage the tray usage order according to the usage-order determination rule 1, in the present exemplary embodiment, a priority order is assigned to the sheet feed trays according to the chronologically ascending order of timings at which sheets are supplied to the respective trays. For such management, the supply of sheets to the sheet feed trays needs to be detected. Accordingly, in this exemplary embodiment, the image forming apparatus 1 detects the opening and closing of each sheet feed tray performed during sheet supply with a sensor provided in each sheet feed tray, and predicts the supply of sheets to each sheet feed tray through a detection signal of the sensor.

The operation of managing the usage order of the sheet feed trays is performed according to the following procedure.

The image forming apparatus 1 recognizes a sheet feed tray to which sheets have been supplied by the detection signal output from each sensor for detecting the opening and closing of each tray. The supplied tray is a sheet feed tray to which sheets have been supplied most recently, and therefore has a lowest priority according to the usage-order determination rule 1. Accordingly, in the sheet-tray table 2 of FIG. 4, the supplied tray is written at a position having a lowest priority, that is, at the end of a line of tray numbers.

Such management of the tray usage order allows the highest priority to be constantly assigned to a sheet feed tray containing the earliest supplied sheets. Such sheet feeding operation from the tray containing the earliest supplied sheets may meet the needs of users that earlier supplied sheets should be used ahead of more recent supplied sheets.

[Usage-Order Determination Rule 2]

Next, a second example of the rule for determining the variable tray-usage order is described.

The second example is a rule that the tray usage order is determined according to the ascending order of the number of remaining sheets, that is, the order of the smaller number of remaining sheets (hereinafter “usage-order determination rule 2”).

To manage the tray usage order according to the usage-order determination rule 2, the number of remaining sheets in each sheet feed tray needs to be detected. Accordingly, in this exemplary embodiment, the image forming apparatus 1 detects a height of sheets stacked in each sheet feed tray with a sensor, and calculates the number of remaining sheets in each tray from the measured height of the stack.

The operation of managing the usage order of sheets is performed according to the following procedure.

The number of sheets remaining in each tray is calculated from a detection signal of the sensor provided to each tray, and the order of the number of remaining sheets is determined base on the calculation results. Accordingly, in the sheet-tray table 2 of FIG. 4, a sheet feed tray with the smallest number of remaining sheets is written at a position of highest priority, that is, at the head of each line. Subsequently, other sheet feed trays having sheets of identical size follow in an ascending order of the number of remaining sheets.

Such management of the tray usage order allows sheets of identical size to be fed from sheet feed trays in an ascending order of the number of remaining sheets. As a result, a reasonable sheet feeding operation can be performed to allow a user to directly supply a stack of sheets to a sheet feed tray having run out of sheets.

[Mode Setting of Variable Tray-Usage Order]

Next, still another exemplary embodiment is described below.

In the above description, the two usage-order determination rules 1 and 2 are described as examples of the rule for determining a variable order in which a plurality of sheet feed trays are used. A user is preferably allowed to choose any of the determination rules 1 and 2 according to needs. Accordingly, in the present exemplary embodiment, the image forming apparatus 1 is configured so that a user can choose one of the determination rules and designate a mode setting.

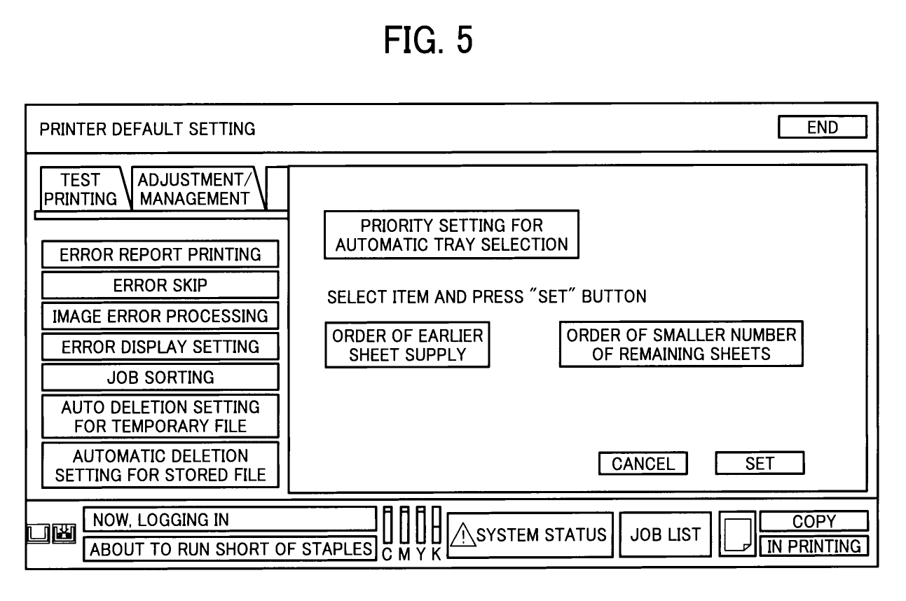

FIG. 5 illustrates an example of a mode setting screen displayed on an LCD touch panel of the operation panel 4.

In the present exemplary embodiment, such mode setting can be performed through a default setting of the image forming apparatus 1. As illustrated in FIG. 5, a window displayed with a title of “PRIORITY SETTING FOR AUTOMATIC TRAY SELECTION” can be called through a menu screen of the default setting. In the window, buttons are provided so that a user can choose one of the “ORDER OF EARLIER SHEET SUPPLY” (usage-order determination rule 1) and the “ORDER OF SMALLER NUMBER OF REMAINING SHEETS” (usage-order determination rule 2). When a user presses one of the buttons and then presses a “set” button, the mode setting is completed.

Further, as another exemplary embodiment, when the setting of the tray usage order is not performed through the screen illustrated in FIG. 5, a predetermined usage order as described with the table of FIG. 2 may be used. When a variable usage order is set, the mode setting may be designated through the screen of FIG. 5.

[Management of Sheet-Tray Table at the End of Print Job]

Typically, control condition and other settings are initialized after finishing one print job and before accepting another print job.

In sheet feed control using a sheet-tray table, initialization is performed at a timing for switching from one print job to another print job. As a result, with a normal operation, such sheet-tray table is initialized. At this time, for example, in the sheet-tray table of FIG. 2, a leading tray in a predetermined tray usage order is written and selected as a tray to be used for sheet feeding. Such selection may be performed every time the table is initialized. Consequently, the sheet feeding operation from a sheet feed tray used in the preceding print job cannot be inherited and thus sheets may remain unused in the sheet feed tray.

Accordingly, in order to use all sheets in the tray before switching to another tray containing identical-size sheets, such sheet-tray table is managed, for example, by the following method. In the initialization process typically performed before accepting the next print job, the sheet-tray table used for print output of the preceding print job is not initialized but held as is. Thus, the next print job can inherit the sheet feeding control from the sheet feed tray used for print output of the preceding print job.

As described above, such management of passing a sheet-tray table from one print job to the next allows sheets to be fed from a single sheet feed tray. As a result, all the sheets can be used without any being left in the sheet feed tray.

[Management of Sheet-Tray Table in Turning Power on and Off]

When the power of the image forming apparatus 1 is turned off and then turned on, control condition and/or other settings are initialized.

In sheet feed control performed with a sheet-tray table, the sheet-tray table is initialized when the power is restored. At this time, similar to the end of a print job described above, another tray to be used for sheet feeding is newly selected. Consequently, the sheet feeding operation from the sheet feed tray used when the power is turned off cannot be inherited, and thus sheets may remain unused in the sheet feed tray.

Accordingly, in order to use all the sheets in one sheet feed tray before switching to another tray containing identical-size sheets, there are, for example, the following two methods of managing such sheet-tray table.

[1. Reproduction of Sheet-Tray Table Used when Power is Turned Off]

In one management method, a sheet-tray table used when power is turned off is stored in a non-volatile storage device such as the HDD 17 or the NVRAM 11. Then, when the power is turned on, the sheet-tray table stored in the storage device is reloaded into a working memory such as the RAM 10.

In either of the above-described exemplary embodiments using a predetermined tray-usage order (see FIG. 2) and a variable tray-usage order (see FIG. 4), a sheet-tray table used when the power is turned off is stored in such non-volatile storage device. Then, when the power is restored, the setting of sheet feed control performed when the power is turned off is reproduced.

By managing such sheet-tray table according to the above-described method when the power is turned on and off, sheets can be fed from a sheet feed tray identical to that used before shutdown, and thus all the sheets in the sheet feed tray can be used without any being left in the sheet feed tray.

[2. Resetting of Tray Usage Order]

The above-described method has an advantage in that it is easy for a user to understand it. However, when the tray usage order is determined according to an ascending order of the number of remaining sheets (usage-order determination 2), a variation in the number of remaining sheets in each tray may be generated, for example, when a user supplies sheets to a sheet feed tray while the power is off. In such case, even if the sheet-tray table stored when the power is turned off is reproduced, the rule cannot be kept.

Accordingly, in the case where the tray usage order is determined according to the usage-order determination rule 2, an ascending order of the number of remaining sheets among the sheet feed trays is determined in an initializing process executed when the power is restored, and then the sheet-tray table is reset.

Thus, by managing the sheet-tray table when the power is turned on and off, the image forming apparatus 1 can perform a sheet feed control using a sheet-tray table suitable for a current state of the number of sheets remaining in each tray. As a result, all sheets in a sheet feed tray can be used without any being left in the sheet feed tray.

[Application to Multi-Functional Device]

Although the image forming apparatus 1 in the above-described exemplary embodiments is described as a printer, an image forming apparatus according to another exemplary embodiment may be a copier, a scanner, a printer, or a multi-functional device capable of performing functions of any two of the precedent devices. For example, in the case of a multi-functional device, sheet feed control using a sheet-tray table needs to be coordinated among the respective functions.

Accordingly, a common sheet-tray table is used among all functions. When processing a job designated in a print request, each function refers to the common sheet-tray table. As a result, when sheet feeding is performed using any of the functions, sheets of identical size can be fed from a single sheet feed tray until the tray runs out of the sheets.

Exemplary embodiments of the present invention may be conveniently implemented using a conventional general purpose digital computer programmed according to the teachings of the present specification, as will be apparent to those skilled in the computer art. Appropriate software coding can readily be prepared by skilled programmers based on the teachings of the present invention, as will be apparent to those skilled in the software art. Exemplary embodiments of the present invention may also be implemented by the preparation of application specific integrated circuits or by interconnecting an appropriate network of conventional component circuits, as will be readily apparent to those skilled in the art.

Numerous additional modifications and variations are possible in light of the above teachings. It is therefore to be understood that, within the scope of the appended claims, the disclosure of this application may be practiced otherwise than as specifically described herein.

Further, elements and/or features of different exemplary embodiments and/or examples may be combined with each other and/or substituted for each other within the scope of this disclosure and appended claims.

Still further, any one of the above-described and other exemplary features of the present invention may be embodied in the form of an apparatus, method, system, computer program, or computer program product. For example, the aforementioned methods may be embodied in the form of a system or device, including, but not limited to, any of the structures for performing the methodology illustrated in the drawings.

Even further, any of the aforementioned methods may be embodied in the form of a program. The program may be stored on a computer readable medium and configured to perform any one of the aforementioned methods when run on a computer device (a device including a processor). Thus, the storage medium or computer readable medium can be configured to store information and interact with a data processing facility or computer device to perform the method of any of the above-described embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media (such as CD-ROMs and DVDs), magneto-optical storage media (such as MOs), magnetic storage media (including but not limited to floppy diskettes, cassette tapes, and removable hard disks), media with a built-in rewriteable non-volatile memory (including but not limited to memory cards), and media with a built-in ROM (including but not limited to ROM cassettes), etc. Furthermore, various information regarding stored images, for example, property information, may be stored in any other form, or provided in other ways.

Examples and embodiments being thus described, it should be apparent to one skilled in the art after reading this disclosure that the examples and embodiments may be varied in many ways. Such variations are not to be regarded as a departure from the spirit and scope of the present invention, and such modifications are not excluded from the scope of the following claims.

What is claimed is:

1. An image forming apparatus comprising:
a plurality of sheet feed trays configured to contain recording sheets;
a tray information management unit to associate tray identification information on the plurality of sheet feed trays with sheet type information on sheet types of recording sheets contained in each sheet feed tray of the plurality of sheet feed trays as tray information;
a sheet feed control unit to select, from among the plurality of sheet feed trays, one sheet feed tray containing a recording sheet of one sheet type designated in an image forming request by referring to the tray information managed by the tray information management unit, and to control a sheet feeding operation for feeding the recording sheet from the selected sheet feed tray; and
an image forming unit to form an image on the recording sheet fed from the selected sheet feed tray according to image forming data input with the image forming request.

2. The image forming apparatus according to claim 1, wherein the tray information management unit manages usage order setting information defining a tray usage order in which at least two sheet feed trays containing recording sheets of an identical sheet type among the plurality of sheet feed trays are used for sheet feeding and rewrites the tray information to which the sheet feed control unit refers, when a first sheet feed tray of the at least two sheet feed trays runs out of sheets to select a second sheet feed tray to be used next from among the at least two sheet feed trays according to the tray usage order defined in the usage order setting information.

3. The image forming apparatus according to claim 2, wherein the tray usage order is a predetermined and fixed order.

4. The image forming apparatus according to claim 2,
wherein the tray usage order is variable, and
wherein, when the first feed tray runs out of sheets, the tray information management unit checks state of the at least two sheet feed trays, updates the tray usage order based on the checked state, and manages the updated tray usage order as the usage order setting information.

5. The image forming apparatus according to claim 2, wherein the tray usage order is variable based on loading time of recording sheets to the plurality of sheet feed trays.

6. The image forming apparatus according to claim 2, wherein the tray usage order is variable based on number of recording sheets remaining in the plurality of sheet feed trays.

7. The image forming apparatus according to claim 2, further comprising an operation unit to set operating conditions,
wherein, through the operation unit, the tray usage order is selectable between loading time of recording sheets to the plurality of sheet feed trays and number of recording sheets remaining in the plurality of sheet feed trays.

8. The image forming apparatus according to claim 2, further comprising a sensor to detect opening and closing of each sheet feed tray,
wherein, when the sensor detects opening and closing of the corresponding sheet feed tray of the plurality of sheet feed trays, the tray information management unit assigns the corresponding sheet feed tray to a last position in the tray usage order.

9. The image forming apparatus according to claim 2, further comprising a sensor to detect a number of recording sheets remaining in each sheet feed tray of the plurality of sheet feed trays,
wherein the tray information management unit resets the tray usage order based on the number of recording sheets remaining in each sheet feed tray of the plurality of sheet feed trays detected by the sensor.

10. The image forming apparatus according to claim 2,
wherein the image forming apparatus has a plurality of image forming functions, and
wherein the tray information management unit causes the tray information and the usage order setting information to be shared among the plurality image forming functions.

11. The image forming apparatus according to claim 2, wherein the tray information management unit retains the tray information and the usage order setting information after one image forming job is completed and applies the retained tray information and usage order setting information to a subsequent image forming job.

12. The image forming apparatus according to claim 2, further comprising a storage unit capable of retaining information when the image forming apparatus is turned off and then on again,
wherein the tray information management unit causes the storage unit to retain the tray information and the usage order setting information when the image forming apparatus is turned off, and applies the tray information and the usage order setting information retained in the storage unit to an image forming job when the image forming apparatus is turned on again.

13. The image forming apparatus according to claim 2, wherein, when the image forming apparatus is turned off and then on again, the tray information management unit initializes the tray information and the usage order setting information according to a predetermined rule.

14. A method of forming an image on a recording sheet, the method comprising:
associating tray identification information on a plurality of sheet feed trays with sheet type information on sheet types of recording sheets contained in each sheet feed tray of the plurality of sheet feed trays as tray information using a tray information management unit;
selecting, from among the plurality of sheet feed trays, one sheet feed tray containing a recording sheet of one sheet type designated in an image forming request by referring to the tray information managed by the tray information management unit; and
controlling a sheet feeding operation for feeding the recording sheet from the selected sheet feed tray to form an image on the recording sheet fed from the selected sheet feed tray according to image forming data input with the image forming request.

15. A computer-readable storage medium storing a computer program that causes a computer to execute a method of forming an image on a recording sheet,
the method comprising:
associating tray identification information on a plurality of sheet feed trays with sheet type information on sheet types of recording sheets contained in each sheet feed tray of the plurality of sheet feed trays as tray information using a tray information management unit;
selecting, from among the plurality of sheet feed trays, one sheet feed tray containing a recording sheet of one sheet type designated in an image forming request by referring to the tray information managed by the tray information management unit; and
controlling a sheet feeding operation for feeding the recording sheet from the selected sheet feed tray to form an image on the recording sheet fed from the selected sheet feed tray according to image forming data input with the image forming request.
